(19) United States
(12) Patent Application Publication
(10) Pub. No.: US 2020/0407653 A1
(43) Pub. Date: Dec. 31, 2020

(54) FACILITY FOR THE TREATMENT OF A STREAM OF METHANE AND CARBON DIOXIDE BY MEANS OF A VANE-TYPE COMPRESSOR AND OF A MEMBRANE SEPARATION UNIT

(71) Applicant: L'Air Liquide, Societe Anonyme pour l'Etude et l'Exploitation des Procedes Georges Claude, Paris (FR)

(72) Inventor: Francois BARRAUD, Sassenage (FR)

(73) Assignee: L'Air Liquide, Societe Anonyme pour l'Etude et l'Exploitation des Procedes Georges Claude, Paris (FR)

(21) Appl. No.: 16/914,057

(22) Filed: Jun. 26, 2020

(30) Foreign Application Priority Data
Jun. 26, 2019 (FR) FR 1906949

(51) Int. Cl. C10L 3/10; B01D 53/22

(52) U.S. Cl. CPC C10L 3/104; B01D 53/229; C10L 2290/548; C10L 2290/58; B01D 2256/245; B01D 2257/504; C10L 2290/46

(57) ABSTRACT

Facility for the treatment of a feed gas stream comprising at least methane and carbon dioxide, said facility comprising:
an oil-lubricated or water-lubricated vane-type compressor making it possible to compress the feed gas stream, and
a membrane separation unit capable of receiving the compressed gas stream and of separating the methane from the carbon dioxide.

### CROSS-REFERENCE TO RELATED APPLICATIONS

This application claims the benefit of priority under 35 U.S.C. § 119 (a) and (b) to French patent application No. FR 1 906 949, filed Jun. 26, 2019, the entire contents of which are incorporated herein by reference.

### BACKGROUND

### Field of the Invention

The present invention relates to a facility for the membrane permeation treatment of a feed gas stream containing at least methane and carbon dioxide in order to produce a methane-rich gas stream, of which the methane content meets the requirements of its use, and to a process for the treatment of such a feed gas stream using said facility.

The invention relates in particular to the compression of biogas, for the purpose of producing biomethane in accordance with the specifications for injection into a natural gas network.

### Related Art

Biogas is the gas produced during the decomposition of organic matter in the absence of oxygen (anaerobic fermentation), also known as methanization. This can be natural decomposition—it is thus observed in marshland or in household waste landfills—but the production of biogas can also result from the methanization of waste in a dedicated reactor, known as methanizer or digester.

Due to its main constituents—methane and carbon dioxide—biogas is a powerful greenhouse gas; at the same time, it also constitutes a source of renewable energy which is appreciable in the context of the increasing scarcity of fossil fuels.

Biogas contains predominantly methane (CH₄) and carbon dioxide (CO₂) in proportions which can vary according to the way in which it is obtained, but also contains, in smaller proportions, water, nitrogen, hydrogen sulfide, oxygen and other organic compounds, in the form of traces.

Depending on the organic matter which has decomposed and on the techniques used, the proportions of the components differ but, on average, biogas comprises, on a dry gas basis, from 30% to 75% of methane, from 15% to 60% of CO₂, from 0% to 15% of nitrogen, from 0% to 5% of oxygen and trace compounds.

Biogas is made use of economically in various ways. It can, after a gentle treatment, be exploited close to the production site in order to supply heat, electricity or a mixture of both (cogeneration). The high carbon dioxide content reduces its calorific value, increases the costs of compression and of transportation and limits the economic advantage of making use of it economically to this use nearby.

More intensive purification of biogas allows it to be more widely used; in particular, intensive purification of biogas makes it possible to obtain a biogas which has been purified to the specifications of natural gas and which can be substituted for the latter; biogas thus purified is known as “biomethane”. Biomethane thus supplements the natural gas resources with a renewable proportion produced within the territories. It can be put to exactly the same uses as natural gas of fossil origin. It can feed a natural gas network or a vehicle filling station. It can also be liquefied to be stored in the form of liquefied natural gas (LNG).

The ways in which biomethane is made use of economically are determined according to local contexts: local energy requirements, possibilities of making use of economically as biomethane fuel and existence close to natural gas distribution or transportation networks, in particular. By creating synergy between the various parties operating in a given territory (farmers, manufacturers, civic authorities), the production of biomethane assists the territories in acquiring greater energy autonomy.

Several steps need to be completed between collecting the biogas and obtaining the biomethane, the end product capable of being compressed or liquefied.

In particular, several steps are necessary before the treatment which is aimed at separating the carbon dioxide in order to produce a stream of purified methane.

A first step consists in compressing the biogas that has been produced and conveyed at atmospheric pressure; the present invention relates to the technology for performing this step.

The following steps are aimed at freeing the biogas of the corrosive components, which are hydrogen sulfide and volatile organic compounds (VOCs); the technologies used are, conventionally, pressure swing adsorption (PSA) and trapping on activated carbon. Next comes the step which consists in separating the carbon dioxide in order ultimately to have available methane at the purity required for its subsequent use.

Carbon dioxide is a contaminant typically present in natural gas and it is common to need to remove it therefrom. Varying technologies are used for this depending on the situation. Among these, membrane technology performs particularly well when the CO₂ content is high\ and is therefore particularly effective for separating the CO₂ present in biogas, and in particular, in landfill gas.

Membrane gas separation methods used for purifying a gas, whether they employ one or more membrane steps, need to make it possible to produce a gas at the required quality, at a low cost, while at the same time minimizing the losses of the gas that is to be put to profitable use. Thus, in the case of biogas purification, the separation performed is chiefly a CH₄/CO₂ separation which needs to allow the production of a gas containing, depending on its use, more than 85% CH₄, preferably more than 95% CO₂, more preferentially more than 97.5% CH₄, while minimizing the CH₄ losses in the residual gas and the cost of purification, the latter to a large extent being associated with the electricity consumption of the device that compresses the gas upstream of the membranes.

### SUMMARY OF THE INVENTION

Thus, the present invention is a facility for the treatment of a feed gas stream comprising at least methane and carbon dioxide, said facility comprising:
an oil-lubricated or water-lubricated vane-type compressor making it possible to compress the feed gas stream, and
a membrane separation unit capable of receiving the compressed gas stream and of separating the methane from the carbon dioxide.

The vane-type compressor suctions the gas stream via an intake opening and directs it to a housing which experiences a reduction in its volume due to the rotation of the blades and thus increases the pressure of this gas stream.

A particularly precise lubrication is of vital importance for the operation of the vane-type compressors, not only for the bearings of the rotor, but also inside the housing in order to limit the friction between the blades and the housing itself, so as to ensure both the leaktightness and protection.

Oil or water is used for this lubrication.

Depending on the case, the facility according to the invention may have one or more of the following features:
it comprises at least one pressure sensor for measuring the pressure of the feed gas stream at the inlet of the membrane separation unit, a controller (which may be a programmable logic controller or computer) for comparing with a target value, the controller being adapted and configured to adjust the compression of the feed gas stream within the vane-type compressor;
the lubricated vane-type compressor is adapted and configured to increase the pressure of the feed gas stream to a pressure between 6 and 13 barg;
the membrane separation unit comprises a first membrane separation subunit adapted and configured to receive the gas stream leaving the adsorbers and to produce a first carbon dioxide-enriched permeate and a first methane-enriched retentate, a second membrane separation subunit adapted and configured to receive the first retentate and to produce a second carbon dioxide-enriched permeate and a second methane-enriched retentate, a third membrane separation subunit adapted and configured to receive the first permeate and to produce a third methane-enriched retentate and a third CO₂-enriched permeate.

### DETAILED DESCRIPTION OF THE INVENTION

A subject of the present invention is also a process for treating a feed gas stream comprising at least methane and carbon dioxide in order to produce a methane-enriched gas stream, using a facility according to the invention and comprising:
a) a step of compressing the feed gas stream to a pressure of between 6 and 13 barg by means of the oil-lubricated or water-lubricated vane-type compressor,
b) a step of eliminating and filtering the impurities and the water vapours or oil vapours,
c) a step of separating the carbon dioxide and methane in the membrane separation unit,
d) a step of measuring the pressure of the feed gas stream at the inlet of the membrane separation unit,
e) a step of comparing the measurement taken in step c) with a target value, and
f) in the event of a difference between the measurement taken and the target value, a step of modifying the compression of the feed gas stream within the vane-type compressor.
   Depending on the case, the process according to the invention can exhibit one or more of the following features:
steps d), e) and f) are carried out automatically by data transmission and data processing means, the data transmission and data processing means being a controller, such as a programmable logic controller or computer;
steps a) to f) are carried out continuously;
the feed gas stream is biogas.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a simile step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A facility for the treatment of a feed gas stream comprising at least methane and carbon dioxide, said facility comprising:
an oil-lubricated or water-lubricated vane-type compressor adapted and configured to compress the feed gas stream; and
a membrane separation unit in fluid communication with the compressor that is adapted and configured to receive the compressed gas stream and separate the methane from the carbon dioxide therein.

2. The facility of claim 1, further comprising:
at least a pressure sensor adapted and configured to measure a pressure of the feed gas stream at an inlet of the membrane separation unit; and
a controller that is adapted and configured to compare a pressure measured by the at least a pressure sensor with a target value, and adjust compression of the feed gas stream within the vane-type compressor.

3. The facility of claim 1, wherein the lubricated vane-type compressor is adapted and configured to increase the pressure of the feed gas stream to a pressure between 6 and 13 barg.

4. The facility of claim 1, wherein the membrane separation unit comprises:
a first membrane separation subunit adapted and configured to receive the gas stream leaving the adsorbers and to produce a first carbon dioxide-enriched permeate and a first methane-enriched retentate;
a second membrane separation subunit adapted and configured to receive the first retentate and to produce a second carbon dioxide-enriched permeate and a second methane-enriched retentate; and
a third membrane separation subunit adapted and configured to receive the first permeate and to produce a third methane-enriched retentate and a third CO₂-enriched permeate.

5. A process for treating a feed gas stream comprising at least methane and carbon dioxide in order to produce a methane-enriched gas stream, using a facility of claim 1, comprising the steps of:
a) compressing the feed gas stream to a pressure of between 6 and 13 barg by means of the oil-lubricated or water-lubricated vane-type compressor;
b) eliminating and filtering, from the compressed feed gas stream, one or more of impurities, water vapor, and oil vapor;
c) separating, in the membrane separation unit, the carbon dioxide and methane in the compressed feed gas stream from which one or more of impurities, water vapor, and oil vapor have been eliminated and filtered;
d) measuring a pressure of the feed gas stream at the inlet of the membrane separation unit; and
e) comparing the measurement taken in step d) with a target value, and in the event of a difference between the measurement taken and the target value, modifying the compression of the feed gas stream within the compressor.

6. The process of claim 5, wherein step e) is carried out automatically by a data transmission and data processing means.

7. The process of claim 5, wherein steps a) to e) are carried out continuously.

8. The process of claim 5, wherein the feed gas stream is biogas.
